(19) United States
(12) Patent Application Publication
(10) Pub. No.: US 2026/0163645 A1
(43) Pub. Date: Jun. 11, 2026

(54) SYSTEMS AND METHODS FOR OPTICAL COMMUNICATION WITH POLARIZATION DIVERSITY

(71) Applicant: Lightmatter, Inc., Boston, MA (US)

(72) Inventors: Joyce Poon, Toronto (CA); Nikhil Kumar, East Palo Alto, CA (US); Brian Donovan Jones, Jamaica Plain, MA (US); Kuang Liu, Queen Creek, AZ (US); Clifford Chao, Palo Alto, CA (US); Anthony Kopa, Somerville, MA (US); Geoffrey Tu, Mountain View, CA (US); Daniel Stodolsky, Cambridge, MA (US); Darius Bunandar, Boston, MA (US)

(73) Assignee: Lightmatter, Inc., Boston, MA (US)

(21) Appl. No.: 19/413,599

(22) Filed: Dec. 9, 2025

Related U.S. Application Data
(60) Provisional application No. 63/730,082, filed on Dec. 10, 2024.

(51) Int. Cl. H04B 10/40; H04B 10/25

(52) U.S. Cl. CPC H04B 10/40; H04B 10/25

(57) ABSTRACT

Described herein are systems and techniques for a bidirectional polarization diverse optical transceivers. When an optical signal propagates along a single mode fiber, the single polarization mode gets rotated and may arrive at an optical transceiver with an arbitrary superposition of two orthogonal polarization modes, each of which experience differing optical effects. The bidirectional optical transceivers described herein include one or more features for addressing the differing optical effects so that both polarization modes are received at substantially a same time.

### RELATED APPLICATIONS

This application claims the benefit under 35 U.S.C. § 119(e) of U.S. Provisional Application No. 63/730,082 filed Dec. 10, 2024, entitled “OPTICAL COMMUNICATION WITH POLARIZATION DIVERSITY AND POLARIZATION MULTIPLEXING,” which is hereby incorporated by reference in its entirety.

### BACKGROUND

Optical interconnects are a type of communication technology that use light signals to transmit data between different components or devices within a system. These interconnects replace traditional electrical connections, such as copper wires or traces on a circuit board, with optical fibers or waveguides. In optical interconnects, data is converted into light signals using optical transmitters, typically lasers or light-emitting diodes (LEDs) combined with optical modulators. These light signals travel through optical fibers or waveguides, which are made of materials that can efficiently guide and transmit light with minimal loss. At the receiving end, optical receivers convert the incoming light signals back into electrical signals that can be processed by electronic devices.

### SUMMARY

In optical interconnect systems that utilize single mode fibers, as the optical signals propagate through the fiber, the polarization of the optical signals may get mixed from the input mode into a superposition of two orthogonal modes. These different modes of light may experience different optical effects such as differential group velocities or different optical paths through an optical system. However, the information carried by the optical signal is encoded in the combined magnitude of the two modes and thus, should be received by a receiver at substantially the same time. Accordingly, described herein are systems and techniques for addressing the delays caused by the different optical effects experienced by the two orthogonal modes of an optical signal.

In some aspects, the techniques described herein relate to a bidirectional optical transceiver including: a fiber port; an optical transmitter coupled to the fiber port; an optical receiver coupled to the fiber port and having a plurality of optical filters, each optical filter is configured to filter light at a respective carrier wavelength, each optical filter including a first optical path for receiving optical signals from a first input of the optical receiver and a second optical path for receiving optical signals from a second input of the optical receiver, wherein the first optical path and the second optical path have different optical lengths; a polarization splitter rotator (PSR) having a first port coupled to the first input of the optical receiver and a second port coupled to the second input of the optical receiver; and an interleaver coupled between the first port of the PSR and the first input of the optical receiver.

In some aspects, the techniques described herein relate to a bidirectional optical transceiver, wherein: the PSR is configured to: split an incoming optical signal into a first mode optical signal having a first polarization and a second mode optical signal having a second polarization; process the second mode optical signal to rotate the second polarization to be parallel to the first polarization; and output the first mode optical signal through the first port and the second mode optical signal through the second port.

In some aspects, the techniques described herein relate to a bidirectional optical transceiver, further including: a delay unit coupled between the second port of the PSR and the second input of the optical receiver.

In some aspects, the techniques described herein relate to a bidirectional optical transceiver, wherein: the delay unit is configured to synchronize the first mode optical signal with the second mode optical signal as the first and second mode optical signals arrive at the optical receiver.

In some aspects, the techniques described herein relate to a bidirectional optical transceiver, wherein: the delay unit includes a tunable active component configured to compensate for a delay between the first and second mode optical signals.

In some aspects, the techniques described herein relate to a bidirectional optical transceiver, wherein: the active component includes a ring resonator.

In some aspects, the techniques described herein relate to a bidirectional optical transceiver, wherein: the optical receiver includes an optical bus coupling the first input to the second input; and the plurality of optical filters are evanescently coupled to the optical bus and are configured to receive the first mode optical signal from the first input at the first optical path and to receive the second mode optical signal from the second input at the second optical path.

In some aspects, the techniques described herein relate to a bidirectional optical transceiver, wherein: a first optical filter of the plurality of optical filters is coupled to the optical bus at a location having a first distance from the first input and a second distance from the second input, the first distance being longer than the second distance; and the second optical path of the first optical filter has an optical length longer than the first optical path of the first optical filter.

In some aspects, the techniques described herein relate to a bidirectional optical transceiver, wherein: a second optical filter of the plurality of optical filters is coupled to the optical bus at a location having a third distance from the first input and a fourth distance from the second input, the fourth distance being longer than the third distance; and the first optical path of the second optical filter has an optical length longer than the second optical path of the second optical filter.

In some aspects, the techniques described herein relate to a bidirectional optical transceiver, wherein: the optical receiver includes a plurality of optical sensors coupled to respective optical filters of the plurality of optical filters, each optical sensor having a first anti-reflective surface facing the first optical path and a second anti-reflective surface facing the second optical path.

In some aspects, the techniques described herein relate to a bidirectional optical transceiver, wherein: each of plurality of optical filters includes an optical resonator, wherein the first optical path encompasses a first portion of the resonator in a clockwise direction and the second optical path encompasses a second portion of the optical resonator in a counterclockwise direction.

In some aspects, the techniques described herein relate to a bidirectional optical transceiver, wherein: the interleaver is further coupled between the transmitter and the PSR.

In some aspects, the techniques described herein relate to a bidirectional optical transceiver, wherein: the optical transmitter is configured to transmit light having carrier wavelengths corresponding to a first set of carrier wavelengths; and the optical receiver is configured to receive light having carrier wavelengths corresponding to a second set of carrier wavelengths, wherein the first and second sets of carrier wavelengths are non-overlapping.

In some aspects, the techniques described herein relate to a bidirectional optical transceiver, wherein: wavelengths of the first set of carrier wavelengths alternate with wavelengths of the second set of carrier wavelengths.

In some aspects, the techniques described herein relate to a bidirectional optical transceiver including: an optical receiver having a plurality of optical filters, each optical filter is configured to filter light at a respective carrier wavelength, each optical filter including a first optical path for receiving optical signals from a first input of the optical receiver and a second optical path for receiving optical signals from a second input of the optical receiver, wherein the first optical path and the second optical path have different optical lengths; a polarization splitter rotator (PSR) including a first optical port coupled to the first input of the optical receiver, and a second optical port coupled to the second input of the optical receiver, wherein the PSR is configured to: split an incoming optical signal into a first mode optical signal having a first polarization and a second mode optical signal having a second polarization; process the second mode optical signal to rotate the second polarization to be parallel to the first polarization, and output the first mode optical signal through the first port and the second mode optical signal through the second port; an optical transmitter; and an interleaver coupling the first port of the PSR to the optical transmitter and to the optical receiver.

In some aspects, the techniques described herein relate to a bidirectional optical transceiver, wherein: the optical receiver includes an optical bus coupled between the first input of the optical receiver and the second input of the optical receiver; and the optical filters are evanescently coupled at different locations along the optical bus.

In some aspects, the techniques described herein relate to a bidirectional optical transceiver, wherein: the first polarization is a transverse electric (TE) polarization, and the second polarization is a transverse magnetic (TM) polarization.

In some aspects, the techniques described herein relate to a bidirectional optical transceiver, wherein: each of plurality of optical filters includes an optical resonator, wherein the first optical path encompasses a first portion of the resonator in a clockwise direction and the second optical path encompasses a second portion of the optical resonator in a counterclockwise direction.

In some aspects, the techniques described herein relate to a bidirectional optical transceiver, wherein: the optical transmitter is configured to transmit light having carrier wavelengths corresponding to a first set of carrier wavelengths; and the optical receiver is configured to receive light having carrier wavelengths corresponding to a second set of carrier wavelengths, wherein the first and second sets of carrier wavelengths are non-overlapping.

In some aspects, the techniques described herein relate to a bidirectional optical transceiver, wherein: wavelengths of the first set of carrier wavelengths alternate with wavelengths of the second set of carrier wavelengths.

### BRIEF DESCRIPTION OF THE DRAWINGS

Various aspects and embodiments will be described with reference to the following figures. It should be appreciated that the figures are not necessarily drawn to scale. Items appearing in multiple figures are indicated by the same or a similar reference number in all the figures in which they appear. In the figures:

FIG. 1A is a block diagram of an example optical transceiver, according to some embodiments;

FIG. 1B is a block diagram of the optical transceiver of FIG. 1A showing optical paths through the transceiver, according to some embodiments;

FIG. 2 illustrates an example receiver of the optical transceiver of FIG. 1A, according to some embodiments; and

FIG. 3 is a schematic diagram of an example optical sensor of an optical receiver, according to some embodiments.

### DETAILED DESCRIPTION

Described herein are systems and methods for enabling and improving optical communication employing wavelength division multiplexing (WDM) in view of polarization-dependent optical effects. Conventional optical communication systems typically rely on WDM to increase data transmission capacity of optical fibers. While WDM has significantly enhanced data throughput, the inventors have recognized and appreciated that polarization-dependent optical effects limit conventional WDM systems. In particular, differences in group velocity of transverse electric (TE) and transverse magnetic (TM) modes—which correspond to two orthogonal polarizations—can complicate the photonics used to analyze optical signals. This difference in group velocity due to polarization mode dispersion is referred to as differential group delay (DGD). In systems employing single mode fibers, as the optical signal propagates through the fiber, its polarization gets mixed into a superposition of two orthogonal polarizations. Consequently, the optical path taken by light within a photonic integrated circuit (PIC) can differ for light that is received by the PIC in one mode versus the other.

Some conventional systems address polarization dispersion and DGD using polarization maintaining optical fibers. These types of fibers are shaped to maintain the polarization state of the incoming signal. However, polarization maintaining fibers are more costly and lossy than single mode fibers, making them effective only at short distances.

Some optical systems enable polarization diverse optical communication, which can help mitigate loss in signal quality due to polarization dispersion. Polarization diversity refers to the ability of the optical system to receive and process optical signals, or transmit optical signals, having more than one polarization mode or optical signals that have an unknown superposition of two polarization modes (e.g., a superposition of TE and TM modes).

Conventional systems that accommodate polarization diversity utilize duplicate receive paths—one for light received in one mode (e.g., the TE mode) and one for light received in a second mode (e.g., the TM mode). These duplicate paths typically include a separate WDM detector for both paths. The inventors have recognized and appreciated that duplicating the photonics for the two different modes unnecessarily doubles the size of the photonics needed to extract the data encoded in received optical signals. In particular, duplicating the WDM demultiplexers (WDM demux) and photodetectors not only increases the photonics footprint on the PIC but also doubles the number of controllers needed to achieve WDM demultiplexing and detection.

The inventors have recognized and appreciated that DGD can be accounted for without using duplicate photonics on the PIC, reducing the footprint of the receiver components on the optical transceiver. Instead, a single receiver (e.g., a WDM demux) can be used for detecting both optical signals received in the first and second modes. A receiver module may comprise optical circuitry (e.g., waveguides, optical drop filters, detectors and other optical components) and associated electronic circuitry (e.g., trans-impedance amplifier) for converting optical signals having a set of wavelengths into a set of electrical signals. Accordingly, some embodiments include a receiver module that receives optical signals that arrived at the PIC in the first mode from one side of the receiver module and receives optical signals that arrived at the PIC in the second mode from a different side of the receiver module (e.g., the opposite side). Further, differences in path length associated with the different optical path lengths within the receiver module itself can be compensated for within the receiver module itself.

The inventors have further recognized and appreciated that the DGD accumulated during transmission in the external single-mode optical fiber on which the optical signals arrive at the PIC can be compensated by the same compensator (e.g., delay unit, path length differences) that is used to compensate for DGD accumulated while the light traverses the optical paths on the PIC outside of the receiver module. As DGD may not be constant across various optical signals, the components used to compensate for the DGD may be tunable to account for the variations in DGD.

Further, many conventional optical communication systems are unidirectional, with separate receiver and transmit fibers. The inventors have recognized and appreciated that the DGD techniques described herein can also be used in bidirectional optical communication systems, where a single fiber carries optical signals in both directions. In some embodiments, the transmitted and received signals use different WDM wavelength sets. However, the inventors have recognized and appreciated that a polarization diverse system can also distinguish between transmitted and received signals using different polarization modes.

Accordingly, some embodiments are directed to a transceiver configured to support a bidirectional, polarization diverse optical communication system. For example, the transceiver may be implemented as a PIC of a WDM communication system. The optical communication system may include a plurality of nodes that communicate with each other, one or more of which may comprise a bidirectional optical transceiver as described herein.

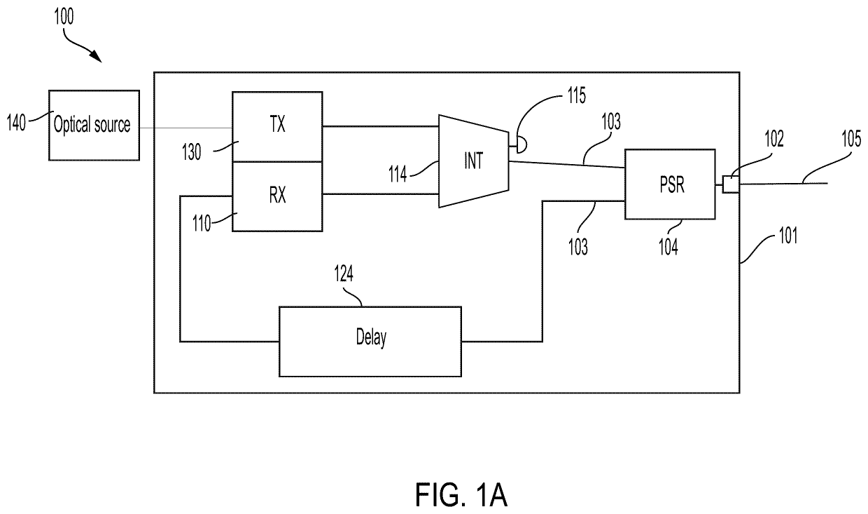

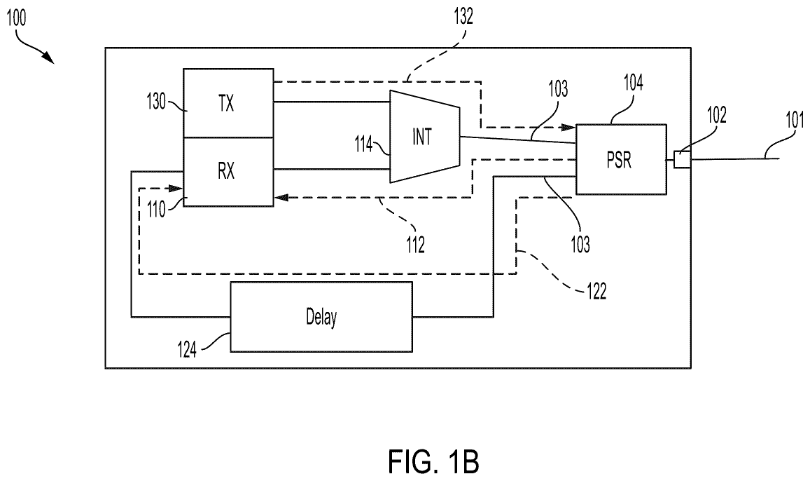

FIG. 1A is a block diagram of an example optical transceiver 100, according to some embodiments. FIG. 1B shows various optical paths that optical signals may take through the optical transceiver 100, according to some embodiments. Optical transceiver 100 comprises a receiver 110, a transmitter 130, an interleaver 114, and a polarization splitter rotator (PSR) 104. Optical transceiver 100 is implemented as a PIC with the components disposed on substrate 101. To optically couple the components together, a plurality of waveguides 103 may be formed in substrate 101. In some embodiments, optical transceiver 100 may include additional components not shown in FIGS. 1A and 1B including, but not limited to, controllers, electrical connections between the controllers and other components, analog-to-digital converters (ADCs), and digital-to-analog converters (DACs).

Optical transceiver 100 may be configured to receive and transmit optical signals through optical fiber 105. Optical fiber 105 may comprise a single mode optical fiber which supports transmission of optical signals having a pair of orthogonal optical modes. Optical fiber 105 is optically coupled to substrate 101 by fiber port 102, which may comprise an edge coupler, a grating coupler, a prism coupler, or any other suitable fiber-PIC coupling mechanism.

The optical signals transmitted and received by optical transceiver 100 may comprise a set of carrier wavelengths. In some embodiments, optical transceiver 100 is configured to receive optical signals having one or more of a first set of carrier wavelengths (λ₁, λ₂, λ₃, . . . λ₈) and transmit optical signals having one or more of a second set of carrier wavelengths (No, λ₁₀, λ₁₁, . . . λ₁₆). To avoid interference as the signals travel along the fiber, the carrier wavelengths of the first set and the carrier wavelengths of the second set may be non-overlapping. In some embodiments, the first set and the second set may be assigned distinct bands of contiguous carrier wavelengths. In some embodiments, the wavelengths of the first set and the second set may alternate.

On the receiver side of optical transceiver 100, optical signals are received via optical fiber 105 by PSR 104. The optical signals may be received as a mix (or superposition) of two orthogonal modes (e.g., TE and TM modes), whereas the transceiver may be configured to operate only in a first of the two modes. In some embodiments, the first mode is the TE mode.

In some embodiments, PSR 104 is configured to split the incoming optical signals into two optical signals—a first mode optical signal corresponding to the first polarization and a second mode optical signal corresponding to the second polarization. PSR 104 may then rotate the polarization of the second mode optical signal to be parallel to the polarization of the first mode optical signal. In that way, the entire received optical signal is transformed to be in the desired polarization. Accordingly, PSR 104 may include a polarization splitter and a polarization rotator.

In some embodiments, PSR 104 may be include an active polarization controller. PSR 104, when configured as an active polarization controller, detects the polarization of the light entering PSR 104 and rotates it to be of the proper polarization for the direction it is propagating (e.g., the first polarization into transceiver 100 and second polarization out). PSR 104, when implemented as a polarization controller, may include a photodiode (not pictured) at a monitoring output of PSR 104 to detect the polarizations of light and adjust the rotation of the optical signal based on the detection. As polarization dispersion is a wavelength dependent effect, using an active polarization controller may enable more efficient splitting of the modes of the optical signal on a wavelength by wavelength basis.

PSR 104 is configured to output the first and second mode optical signals to different optical paths. The first mode optical signal may be output to a waveguide 103 along first optical path 112. First optical path 112 couples PSR 104 to a first input of receiver 110.

In some embodiments, interleaver 114 is coupled along first optical path 112 between PSR 104 and receiver 110. Additionally, in some embodiments, interleaver 114 is coupled along a third optical path 132 between transmitter 130 and PSR 104. An interleaver may be designed to promote selective coupling using a combination of constructive and destructive interference. Wavelengths that are coupled from the transmitter to an optical fiber thanks to constructive interference do not couple to the receiver because of destructive interference. Similarly, wavelengths that are coupled from the optical fiber to the receiver thanks to constructive interference do not couple to the transmitter because of destructive interference. Accordingly, interleaver 114 may be configured to route first mode optical signals received from PSR 104 to receiver 110 and route optical signals to be transmitted from transmitter 130 to PSR 104.

In some embodiments, the routing through optical interleaver 114 is achieved using interferometers designed to provide spectral responses that are a-shifted relative to one another. For example, at one terminal, the interferometer may exhibit a certain spectral response and, at another terminal, the interferometer may exhibit a x-shifted spectral response. Some embodiments employ asymmetric Mach Zehnder interferometers (MZI) to produce this effect.

In some embodiments, interleaver 114 includes a photodiode 115 (shown external to interleaver 114 for clarity). Photodiode 115 may be configured to monitor the functioning of interleaver 114 so that interleaver 114 may be tuned to maximize the optical signals being routed to PSR 104 from transmitter 130. Photodiode 115 may measure the component of the optical signals to be transmitted being routed away from PSR 104 (e.g., to a second port of interleaver 114 rather than the port coupled to PSR 104). When photodiode 115 measures a photocurrent of zero, the entire optical signal to be transmitted is being routed to PSR 104.

PSR 104 is further configured to output the second mode optical signal to a waveguide 103 along second optical path 122, which couples PSR 104 and a second input of receiver 110. In some embodiments, the second input of receiver 110 is on an opposite side of receiver 110 than the first input.

The inventors have recognized and appreciated that the first mode optical signal and the second mode optical signal should be received at receiver 110 at substantially the same time to preserve signal quality. The various components coupled along an optical path may affect the time it takes an optical signal to propagate along the optical path. For example, interleaver 114 may cause a delay in the propagation of the first mode optical signals when compared to a pure waveguide (e.g., with no interleaver 114). Accordingly, second optical path 122 may include delay unit 124 configured to compensate for delay imparted by interleaver 114. In some embodiments, delay unit 124 may be passive where the path length of optical path 122 compensates for the delay. A passive delay unit 124 may include one or more curves (e.g., a winding or serpentine path) to extend the path length of optical path 122 while minimizing the space the waveguides 103 take up on substrate 101. The path length may be determined to compensate for a delay based on the operational wavelength set of receiver 110 (e.g., the first set of wavelengths (λ₁, λ₂, λ₃, . . . λ₈). Passive delay unit enables the optical paths to be tuned to compensate for the different components coupled along the paths, without the need for additional electronic components for controlling delay unit 124.

Additionally or alternatively, in some embodiments, delay unit 124 may include active components configured to tune delay unit 124 (e.g., via a controller) to adjust for variations in the delay. The active components of delay unit 124 may tune delay unit 124 to account for various factors that may affect the delays in the optical paths. In some embodiments, the active components are configured to tune delay unit 124 through the thermo-optic or electro-optic effect. In some embodiments, the active components include a ring resonator, coupled ring resonator (CRR), or other active optical components. Alternatively, or additionally, the delay unit 124 comprises a second interleaver similar to interleaver 114 coupled along optical path 112.

The inventors have further recognized and appreciated that the same delay unit 124 may be used to account for various other delays the optical signals may experience prior to reaching optical paths 112 and 122. For example, as noted above, the first and second mode optical signals may experience a differential group delay while propagating down optical fiber 105 before being received by transceiver 100. Further, the first mode optical signal and second mode optical signal may experience different delays while propagating through PSR 104, for example. Accordingly, delay unit 124 may be configured to account for one or more of the aforementioned delays (e.g., by determining a path length of optical path 122 prior to production, or active tuning). In some embodiments, delay unit 124 includes a path length configured to compensate for one or more of: a differential group delay of the optical signal, a difference in length of the optical paths through which the first mode optical signal and second mode optical signal propagate, second delays imparted to the first mode optical signal and second mode optical signal by PSR 104, and a third delay imparted to the first mode optical signal by interleaver 114.

Transmitter 130 is configured to generate and output optical signals to be transmitted to one or more other optical components (e.g., other optical transceivers 100 coupled through optical fiber 105). Transmitter 130 may receive light from an optical source 140 and modulate the light to encode information and generate optical signals to be transmitted. Optical source 140 may comprise one or more lasers for generating light having the set of wavelengths used by transmitter 130. In some embodiments, the unmodulated light may be received from an external laser or external laser array disposed separately from optical transceiver 100. The unmodulated light may include each of the carrier wavelengths of the transmitter 130 (e.g., second set of wavelengths (λ₉, λ₁₀, λ₁₁, . . . λ₁₆). The encoded optical signals are then output to a waveguide 103 along third optical path 132 and routed to PSR 104 via interleaver 114.

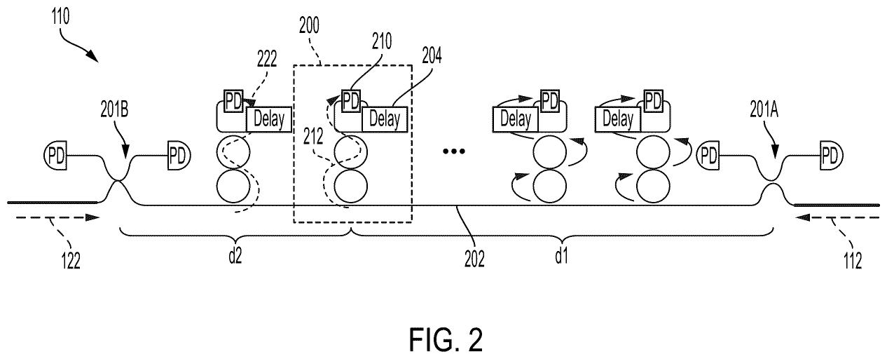

FIG. 2 illustrates an example receiver 110 of the optical transceiver of FIG. 1A, according to some embodiments. In some embodiments, receiver 110 includes a WDM demux. Receiver 110 comprises a plurality of optical filters 200 coupled at different locations along optical bus 202 between first mode input 201A and second mode input 201B. The first mode optical signal is received at first mode input 201A and propagates through optical bus 202 in a first direction whereas the second mode optical signal is received at second mode input 201B and propagates through optical bus 202 in a second direction opposite the first direction.

Each of the optical filters 200 may be configured to extract, from the bus, light at a respective wavelength, whether the light is received from the first input or the second input. For example, each optical filter 200 may be tuned to receive a corresponding WDM wavelength of the first set of wavelengths (λ₁, λ₂, λ₃, . . . λ₈). As the same optical filter 200 is used to receive the same wavelength of the first and second mode optical signals, the optical filters 200 include two optical paths 212 and 222. The optical filters 200 may receive the first mode optical signal from the first mode input 201A in a first direction and the second mode optical signal from the second mode input 201B in a second direction. When received by optical filters 200, the first mode optical signals follow optical path 212 whereas the second mode optical signals follow optical path 222. In the illustrated embodiment, optical filters 200 are implemented as CRRs comprising a series of rings. Optical paths 212 and 222 snake around the series of rings in opposite directions. However, optical filters 200 may be implemented in other configurations including a single ring resonator (rather than two or more rings in series), disk resonators, or any other suitable configuration that can support two optical paths.

Further, each of optical filters 200 may be disposed along optical bus 202 at different distances from first mode input 201A and second mode input 201B. For example, the labeled optical filter 200 is coupled along optical bus 202 at a first distance d1 from first mode input 201A and second distance d2 from the second mode input 201B. Because the path length difference varies depending on where along optical bus 202 optical filter 200 is coupled, the external delay unit (e.g., delay unit 124) may not account for these varying internal delays.

Accordingly, optical filters 200 each include a respective delay unit 204 disposed along one of optical path 212 or optical path 222 so that the first mode optical signals and second mode optical signals of the same wavelength are received at optical sensor 210 at substantially the same time. Whether delay unit 204 is disposed along optical path 212 or optical path 222 depends on where along optical bus 202 optical filter 200 is coupled. When optical filter 200 is further from first mode input 201A (e.g., d1>d2), delay unit 204 is disposed along optical path 222 to account for the longer distance from first mode input 201A, and vice versa when d2>d1. Further, the length of delay unit 204 varies depending on the difference between d1 and d2 of the particular optical filter 200. Delay unit 204 may be configured in any suitable manner. In some embodiments, delay unit 204 may comprise a passive path length difference between optical path 212 and optical path 222. Delay unit 204 may comprise a serpentine or other winding structure of waveguides to increase the path length difference without taking up too much space on substrate 101.

The inventors have recognized and appreciated that some of the light received at optical sensor 210 may be reflected by the input surface. In embodiments where optical filters 200 are implemented as CRRs, this reflection may muddle signal detection as the reflection may cause the light from the first mode optical signal to reflect down optical path 222 and be received at the other detection surface on the other side of the optical detector. This reflection is asynchronous with the received signal and, thus, degrades the data quality of the received optical signal. Accordingly, in some embodiments, the optical sensor may be a low reflectance optical sensor, as described below.

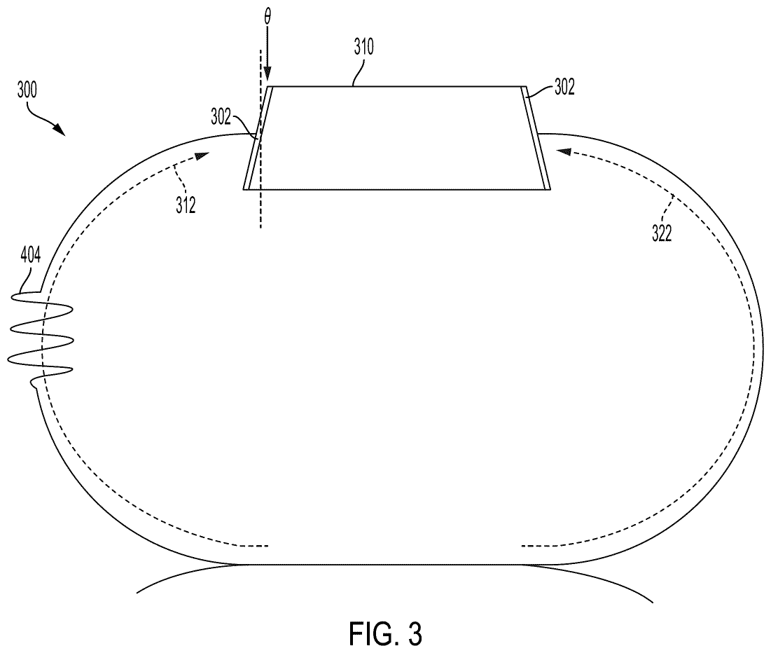

FIG. 3 is a schematic diagram of an example optical sensor 310 of an optical receiver, according to some embodiments. In the illustrated embodiment, optical sensor 310 is implemented as a low reflectance optical sensor having two anti-reflecting surfaces 302. The first detection anti-reflecting 302 receives the respective wavelength of the first mode optical signal along optical path 312 and the second anti-reflecting surface 302 receives the respective wavelength of the second mode optical signal along optical path 322. Although the embodiment illustrates one low-reflectance optical sensor, the system may be configured with two optical sensors, each having a single anti-reflecting surface.

In some embodiments, to achieve low-reflectance at the detection surfaces 302, the detection surfaces may be configured to sit at an angle with respect to the propagation axes of optical paths 312 and 322. For example, in the illustrated embodiment, optical path 312 arrives at the first detection surface 302 substantially horizontally and detection surface 302 is angled away from with respect to optical path 312 at an angle θ. Conventionally, the detection surface 302 is perpendicular. However, a perpendicular surface may reflect portions of the light back down optical path 312 in the opposite direction. Some of the reflected light may propagate around the ring and hit the second detection surface 302 along optical path 322, degrading the signal quality detected by optical sensor 310.

In the illustrated embodiments, the angled surface is configured to reflect any portion of light away from optical path 312 (or optical path 322) so that the reflected light does not propagate in the wrong direction and affect signal quality. In some embodiments, θ is between 30 and 60 degrees away from optical paths 312 or 322. In some embodiments, θ is between 40 degrees and 50 degrees.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments. The definitions, as defined and used herein, should be understood to control over dictionary definitions, definitions in documents incorporated by reference and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some case and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately,” “substantially,” and “about” may be used to mean within ±20% of a target value in some embodiments. The terms “approximately,” “substantially,” and “about” may include the target value.

Use of ordinal terms such as “first,” “second,” “third,” etc., in the claims to modify a claim element does not by itself connotate any priority, precedence, or order of one claim element over another or the temporal order in which acts of a method are performed, but are used merely as labels to distinguish one claim element having a certain name from another claim element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The terms “couple,” “coupled,” and “coupling,” when used in connection with optical components, are to be interpreted broadly to include both direct and indirect coupling. Two optical components are considered directly coupled if there are no intervening components between them. In contrast, two optical components are considered indirectly coupled if there is at least one intervening component between them, provided that the intervening component does not alter the general nature of the interaction between the optical components.

What is claimed is:

1. A bidirectional optical transceiver, comprising:
a fiber port;
an optical transmitter coupled to the fiber port;
an optical receiver coupled to the fiber port and having a plurality of optical filters, each optical filter is configured to filter light at a respective carrier wavelength, each optical filter comprising a first optical path for receiving optical signals from a first input of the optical receiver and a second optical path for receiving optical signals from a second input of the optical receiver, wherein the first optical path and the second optical path have different optical lengths;
a polarization splitter rotator (PSR) having a first port coupled to the first input of the optical receiver and a second port coupled to the second input of the optical receiver; and
an interleaver coupled between the first port of the PSR and the first input of the optical receiver.

2. The bidirectional optical transceiver of claim 1, wherein:
the PSR is configured to:
split an incoming optical signal into a first mode optical signal having a first polarization and a second mode optical signal having a second polarization;
process the second mode optical signal to rotate the second polarization to be parallel to the first polarization; and
output the first mode optical signal through the first port and the second mode optical signal through the second port.

3. The bidirectional optical transceiver of claim 2, further comprising:
a delay unit coupled between the second port of the PSR and the second input of the optical receiver.

4. The bidirectional optical transceiver of claim 3, wherein:
the delay unit is configured to synchronize the first mode optical signal with the second mode optical signal as the first and second mode optical signals arrive at the optical receiver.

5. The bidirectional optical transceiver of claim 3, wherein:
the delay unit comprises a tunable active component configured to compensate for a delay between the first and second mode optical signals.

6. The bidirectional optical transceiver of claim 5, wherein:
the active component comprises a ring resonator.

7. The bidirectional optical transceiver of claim 2, wherein:
the optical receiver comprises an optical bus coupling the first input to the second input; and
the plurality of optical filters are evanescently coupled to the optical bus and are configured to receive the first mode optical signal from the first input at the first optical path and to receive the second mode optical signal from the second input at the second optical path.

8. The bidirectional optical transceiver of claim 7, wherein:
a first optical filter of the plurality of optical filters is coupled to the optical bus at a location having a first distance from the first input and a second distance from the second input, the first distance being longer than the second distance; and
the second optical path of the first optical filter has an optical length longer than the first optical path of the first optical filter.

9. The bidirectional optical transceiver of claim 8, wherein:
a second optical filter of the plurality of optical filters is coupled to the optical bus at a location having a third distance from the first input and a fourth distance from the second input, the fourth distance being longer than the third distance; and
the first optical path of the second optical filter has an optical length longer than the second optical path of the second optical filter.

10. The bidirectional optical transceiver of claim 1, wherein:
the optical receiver comprises a plurality of optical sensors coupled to respective optical filters of the plurality of optical filters, each optical sensor having a first anti-reflective surface facing the first optical path and a second anti-reflective surface facing the second optical path.

11. The bidirectional optical transceiver of claim 1, wherein:
each of plurality of optical filters comprises an optical resonator, wherein the first optical path encompasses a first portion of the resonator in a clockwise direction and the second optical path encompasses a second portion of the optical resonator in a counterclockwise direction.

12. The bidirectional optical transceiver of claim 1, wherein:
the interleaver is further coupled between the transmitter and the PSR.

13. The bidirectional optical transceiver of claim 1, wherein:
the optical transmitter is configured to transmit light having carrier wavelengths corresponding to a first set of carrier wavelengths; and
the optical receiver is configured to receive light having carrier wavelengths corresponding to a second set of carrier wavelengths, wherein the first and second sets of carrier wavelengths are non-overlapping.

14. The bidirectional optical transceiver of claim 13, wherein:
wavelengths of the first set of carrier wavelengths alternate with wavelengths of the second set of carrier wavelengths.

15. A bidirectional optical transceiver, comprising:
an optical receiver having a plurality of optical filters, each optical filter is configured to filter light at a respective carrier wavelength, each optical filter comprising a first optical path for receiving optical signals from a first input of the optical receiver and a second optical path for receiving optical signals from a second input of the optical receiver, wherein the first optical path and the second optical path have different optical lengths;
a polarization splitter rotator (PSR) comprising a first optical port coupled to the first input of the optical receiver, and a second optical port coupled to the second input of the optical receiver, wherein the PSR is configured to:
split an incoming optical signal into a first mode optical signal having a first polarization and a second mode optical signal having a second polarization;
process the second mode optical signal to rotate the second polarization to be parallel to the first polarization, and
output the first mode optical signal through the first port and the second mode optical signal through the second port;
an optical transmitter; and
an interleaver coupling the first port of the PSR to the optical transmitter and to the optical receiver.

16. The bidirectional optical transceiver of claim 15, wherein:
the optical receiver comprises an optical bus coupled between the first input of the optical receiver and the second input of the optical receiver; and
the optical filters are evanescently coupled at different locations along the optical bus.

17. The bidirectional optical transceiver of claim 15, wherein:
the first polarization is a transverse electric (TE) polarization, and
the second polarization is a transverse magnetic (TM) polarization.

18. The bidirectional optical transceiver of claim 15, wherein:
each of plurality of optical filters comprises an optical resonator, wherein the first optical path encompasses a first portion of the resonator in a clockwise direction and the second optical path encompasses a second portion of the optical resonator in a counterclockwise direction.

19. The bidirectional optical transceiver of claim 15, wherein:
the optical transmitter is configured to transmit light having carrier wavelengths corresponding to a first set of carrier wavelengths; and
the optical receiver is configured to receive light having carrier wavelengths corresponding to a second set of carrier wavelengths, wherein the first and second sets of carrier wavelengths are non-overlapping.

20. The bidirectional optical transceiver of claim 19, wherein:
wavelengths of the first set of carrier wavelengths alternate with wavelengths of the second set of carrier wavelengths.
